(19) United States
(12) Patent Application Publication
(10) Pub. No.: US 2019/0362309 A1
(43) Pub. Date: Nov. 28, 2019

(54) SPLITTING AND/OR GROUPING ITEMS IN AN ORDER BASED ON RULES

(71) Applicant: Dell Products L. P., Round Rock, TX (US)

(72) Inventor: Tien Sung Ang, KUALA LUMPUR (MY)

(21) Appl. No.: 15/988,557

(22) Filed: May 24, 2018

(51) Int. Cl. G06Q 10/08

(52) U.S. Cl. CPC G06Q 10/0875

(57) ABSTRACT

In some examples, a server may receive an order to acquire (e.g., purchase or lease) a plurality of items. The server may determine a set of attributes associated with individual items of the plurality of items. The server may select a particular rule from one or more rules. The particular rule may include a rule attribute, a rule condition, and a rule action. The server may determine that a particular attribute of the set of attributes associated with an item of the plurality of items satisfies the rule attribute and the rule condition of the particular rule. In response, the server may perform the rule action by placing the item in a sub-cart based and send the sub-cart to a fulfillment location identified by a fulfillment location identifier attribute of the item.

### BACKGROUND OF THE INVENTION

### Field of the Invention

This invention relates generally to computing devices and, more particularly to receiving a cart with multiple items that are being acquired (e.g., purchased or leased) and splitting and/or grouping the multiple items according to one or more rules.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Electronic commerce (“e-commerce”) may result in various inefficiencies when it comes to order fulfillment. For example, multiple items may each be shipped separately, resulting in unnecessary extra shipping costs. As another example, items that are used together, such as, for example, (i) a laptop computer, (ii) a power supply for the laptop, and (iii) a battery pack for the laptop may each be shipped separately, resulting in increased shipping costs and a poor customer experience because the customer may not receive all three items at the same time. In addition, when an order comes in from an e-commerce website and one or more issues (e.g., insufficient quantity at a warehouse to fulfill the order) are identified, then manual intervention may be required, resulting in increased cost because the order could not be fulfilled automatically and possibly delays as employees attempt to address the issues.

### SUMMARY OF THE INVENTION

This Summary provides a simplified form of concepts that are further described below in the Detailed Description. This Summary is not intended to identify key or essential features and should therefore not be used for determining or limiting the scope of the claimed subject matter.

In some examples, a server may receive an order to acquire a plurality of items. The server may determine a set of attributes associated with individual items of the plurality of items. The server may select a particular rule from one or more rules. The particular rule may include a rule attribute, a rule condition, and a rule action. The server may determine that a particular attribute of the set of attributes associated with an item of the plurality of items satisfies the rule attribute and the rule condition of the particular rule. In response, the server may perform the rule action by placing the item in a sub-cart based and send the sub-cart to a fulfillment location identified by a fulfillment location identifier attribute of the item.

### BRIEF DESCRIPTION OF THE DRAWINGS

A more complete understanding of the present disclosure may be obtained by reference to the following Detailed Description when taken in conjunction with the accompanying Drawings. In the figures, the left-most digit(s) of a reference number identifies the figure in which the reference number first appears. The same reference numbers in different figures indicate similar or identical items.

FIG. 1 is a block diagram of a system that includes multiple rules to split and/or group items in a cart according to some embodiments.

FIG. 2 is a block diagram illustrating applying multiple rules to an order (e.g., cart) according to some embodiments.

FIG. 3 is a block diagram of user interface (UI) to create a rule according to some embodiments.

FIG. 4 is a flowchart of a process that includes applying one or more rules to an order (e.g., cart) according to some embodiments.

FIG. 5 is a flowchart of a process to create a rule according to some embodiments.

FIG. 6 illustrates an example configuration of a computing device that can be used to implement the systems and techniques described herein.

### DETAILED DESCRIPTION

For purposes of this disclosure, an information handling system (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or video display. The information handling system may also include one or more buses operable to transmit communications between the various hardware components.

The systems and techniques described herein provide an organization with a user interface (UI) to enable employees to create rules to apply to an order. An order may be created when a user places items in a cart and performs a checkout, including providing payment information. Once the checkout is completed, the order may be sent to an order fulfillment server where one or more rules are applied as part of processing the order. The rules may perform various actions based on one or more attributes associated with each of the items in the order. For example, a rule may perform an action, such as splitting items in the cart, e.g., based on one or more attributes of the items, and place a first item into a first sub-cart and place a second item into a second sub-cart. To illustrate, if the cart includes an order for a particular quantity of a particular item (e.g., the quantity is an attribute of the particular item), and the particular quantity exceeds a maximum quantity defined in the rule, then a smaller quantity of items may be placed in a first sub-cart (e.g., for fulfillment by a first fulfillment center) and a remained of the items may be placed in a second sub-cart (e.g., for fulfillment by a second fulfillment center). As another example, a rule may perform an action, such as grouping items in the cart, e.g., based on one or more attributes of the items, by placing a first item and a second item into a same sub-cart. To illustrate, some items, such as a power supply, a battery pack, and a warranty may each have an “associated with” (or “child items” of) attribute to link each of them with a laptop and may therefore be grouped into the same sub-cart as the laptop.

A rule engine may apply the rules created by an organization to each order that is received from the organization's ecommerce site. The rules and rule engine may be implemented using a domain specific language (DSL). A UI may enable users to quickly and easily create and modify rules without having to know the underlying programming language. For example, the UI may enable creation of a rule using dropdown menus (or another type of UI element). To illustrate, a user may select an item attribute (e.g., quantity, associated with, or the like), a condition (e.g., present, absent, greater than, less than, equal to, or the like), and an action (e.g., split, group, or the like). After a user uses the UI to specify the parameters associated with rule, the user may add the rule to the rule engine. The UI may, as part of the process of adding the rule, automatically (e.g., without human interaction) create software using the DSL (or another language) that implements the user-specified parameters of the rule. In this way, the rules may be created and maintained by users who may not be software programmers, reducing the costs to create and maintain the rules.

Each rule, implemented in DSL, may perform an action, such as splitting or grouping multiple items, based on attributes of each item. A rule may be defined by an item selector which acts as a conditional input filter to select an item from a set of items in the order. An action may be performed to the filtered item. For example, items with the same attribute (e.g., items being sent from the same warehouse) may be grouped together. As another example, items with the same attribute (e.g., quantity of an ordered item exceeds a threshold amount) may be split into multiple sub-carts (e.g., to enable faster delivery). Because each country or region may have their own particular fulfillment centers (e.g., warehouses), rules may be organized according to country (e.g., United States, Canada, Mexico, and the like) or region (e.g., North America, Central America, Europe, Middle East, Asia, and the like). Some items may be build-to-stock (BTS) where the items are pre-built and stored in a warehouse. Other items may be build-to-order (BTO) where the items are built to the customer's specification that is provided in the order. For example, a user may create a BTO computing device (e.g., tablet, laptop, or desktop) by specifying the type of processor (e.g., Intel® i3, i5, i7), clock speed (e.g., 3.0, 3.6, 3.8 Gigahertz (GHz)), main memory (e.g., 4, 8, or 16 Gigabytes (GB) or random access memory (RAM)), hard drive space (e.g., 512 GB, 1 terabyte (TB), or the like), display device size (e.g., 14″, 15″, 17″, or the like), and other computing device parameters.

The following example of a rule may perform an action (e.g., split or group) to a set of items in an order (e.g., cart) based on FulfillmentLocationld, e.g., an identifier indicating a fulfillment location (e.g., fulfillment center or warehouse):

### {“Type”: “GroupByIdentifier”, “Identifier”: “$.Characteristics.FulfillmentLocationId”}

The following rule may use a ShipWith attribute to group child items with a parent item. The child item's quantity should match the parent's quantity based on the child-parent quantity factor. A ShipWith flag may be set to indicate whether an item's inventory is high enough to merge the child items with the parent item. The ShipWith flag may be used in specific countries or regions (e.g., United States, Canada, and Latin America) when the items are all sourced from a particular country (e.g., the United States:

{“ItemSelector”: “$.Items[?(@.Characteristics.ShipsWithParentItem==‘True’∥@.Characteristics.ShipsWithId>0)]”, “Description”: “Post-split ShipWith feature, move all child items to the parent's bucket.”, “Rules”: [{“Type”: “AssociateByParent”, “Identifier”: “ ”, “Param”:“ ”}]}

It should be noted that the above DSL encoded rules are quite compact. In contrast, such rules may use between about 50 to 100 lines of code in a conventional software application (e.g., using C# or similar language) that does not use a rule engine. Thus, the rule engine simplifies the creation and maintenance of rules and reduces a size of each rule.

Note that the rules may include a wild card operator (e.g., “?”, “*”, or the like). For example, a rule may be created to group or split those items that have a stock keeping unit (SKU) with a common preface of characters. To illustrate, the first N characters of a SKU may identify a particular type of product, thereby enabling all such products to be grouped or split. For example, a laptop may be offered with a standard battery pack while an optional extended battery pack may be available. The battery pack may be a “ships with” item that ships with the associated laptop. If the standard battery pack and the extended battery pack differ only by the last character of their respective SKUs, the use of a wild card for the last character of the SKU (e.g., “NNNNNNNN?”, where “?” is the wild card) may enable the battery pack to be shipped with the laptop, regardless of whether the battery pack is the standard battery pack or the extended battery pack.

Splitting or grouping of items in an order may be performed based on one or more attributes associated with each item. For example, the attributes of an item may include a fulfillment location identifier (e.g., identifying a location from which the item is to be fulfilled), a brand identifier (e.g., identifying a brand or manufacturer of the item), quote number (e.g., a sales person provided a written quote), quantity (e.g., a quantity that exceeds a threshold amount may be split and fulfilled from two or more locations), ships with (e.g., indicating that an item ships with another item), tied to (e.g., indicating that an item is associated with another item), parent-child association (e.g., indicating that an item, such as a warranty, is a child item of another item), and the like.

In a first example, a server may include one or more processors and one or more non-transitory computer readable media storing instructions executable by the one or more processors to perform various operations. The operations may include receiving an order to acquire a plurality of items and determining a set of attributes associated with individual items of the plurality of items. The operations may include selecting a rule from one or more rules. The rule may include a rule attribute, a rule condition, and a rule action. The operations may include determining that a first attribute of a first set of attributes associated with a first item satisfies the rule attribute and the rule condition included in the selected rule, placing the first item in a sub-cart based on the rule action included in the rule, and sending the first sub-cart to a first fulfillment location identified by a fulfillment location identifier attribute in the set of attributes associated with the first item. The operations may include determining that a second attribute of a second set of attributes associated with a second item satisfies the rule attribute and the rule condition included in the rule and placing the second item in the first sub-cart based on the rule action included in the rule. The first set of attributes associated with the first item may include a fulfillment location identifier that identifies a location from which the first item is to be shipped, a brand identifier that identifies a brand or a manufacturer of the first item, a quantity associated with the first item, and a ships-with indicator indicating that the first item ships with another item. The rule condition included in the first rule may include one of: greater than, greater than or equal to, less than, less than or equal to, equal to, including, or excluding. The rule action may include one of: splitting a particular item from the plurality of items by placing the particular item in a particular sub-cart or grouping the particular item with a different item from the plurality of items by placing the particular item and the different item in a same sub-cart. The operations may include determining that a second rule applies to a third item of the plurality of items, placing the third item in a second sub-cart based on a second rule action included in the second rule, and sending the second sub-cart to a second fulfillment location identified by a third fulfillment location identifier in a third set of attributes associated with the third item.

In a second example, one or more non-transitory computer readable media may store instructions executable by one or more processors to perform various operations. For example, the operations may include determining a set of attributes associated with individual items of the plurality of items. The operations may include selecting a rule from one or more rules. The rule may include a rule attribute, a rule condition, and a rule action. The operations may include determining that the rule applies to a first item of the plurality of items, placing the first item in a first sub-cart based on the rule action included in the first rule, and sending the first sub-cart to a first fulfillment location identified by a fulfillment location identifier attribute in the set of attributes associated with the first item. Determining that the first rule applies to the first item of the plurality of items may include determining that a particular attribute of the set of attributes associated with the first item satisfies the rule attribute and the rule condition of the rule. The operations may include determining that the rule applies to a second item of the plurality of items and placing the second item in the first sub-cart based on the rule action included in the first rule. A second set of attributes associated with the second item may include the fulfillment location identifier attribute that is associated with the first item. The second item may include a child attribute indicating that the second item is a child of the first item. The second item may include a ships-with attribute indicating that the second item ships with the first item. The operations may include determining that a second rule applies to a third item of the plurality of items, placing the third item in a second sub-cart based on a second rule action included in the second rule, and sending the second sub-cart to a second fulfillment location identified by a second fulfillment identifier attribute in a third set of attributes associated with the third item.

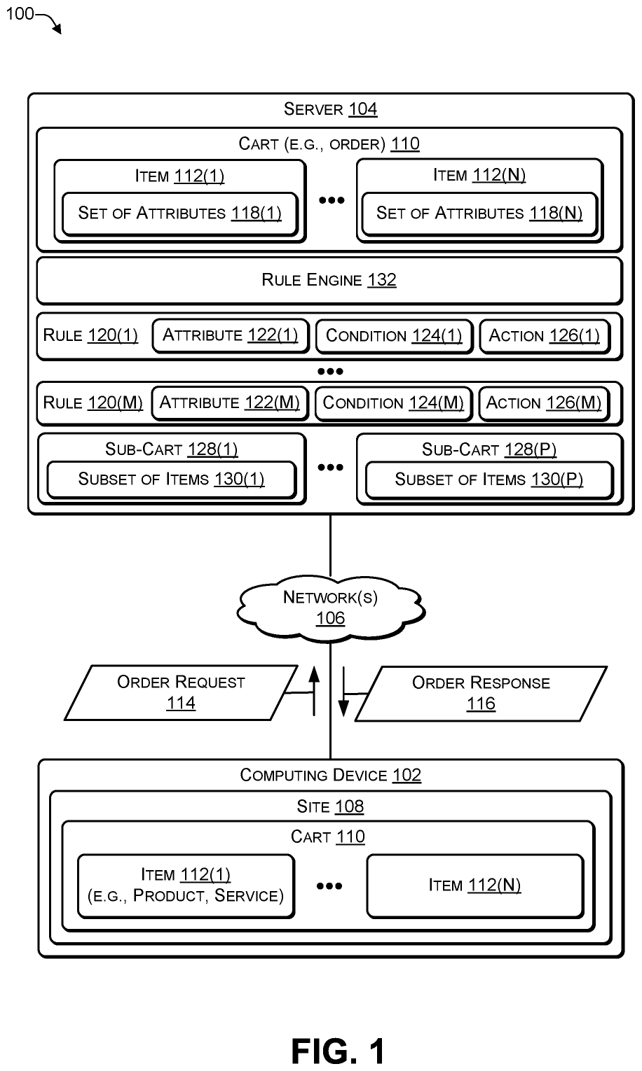

FIG. 1 is a block diagram of a system 100 that includes multiple rules to split and/or group items in a cart according to some embodiments. The system 100 may include a computing device 102 coupled to a server 104 via one or more networks 106.

The computing device 102 may be a laptop, a tablet, a desktop, a phone, or other type of computing device. A user may use the computing device 102 to navigate to a site 108 (e.g., an e-commerce website) and create a cart 110 that includes items 112(1) to 112(N) (where N>1). The items 112 may include products (e.g., hardware, software, and the like), services, or other types of items that the user desires to acquire (e.g., purchase, rent, lease, or the like). In some cases, the user may be an individual user or a small business owner that uses the computing device 102 to navigate to the public site 108. In other cases, the user may be a corporate user that navigates via an enterprise portal to the site 108 that has products and pricing specifically for the corporation (e.g., enterprise). After creating the cart 110 with the items 112, the user may checkout (e.g., by providing payment information, information as to where to ship the items, and the like), causing the computing device 102 to send an order request 114 to the server 104.

In response, the server 104 may process the order request 114 (e.g., to acquire the items 112 in the cart 110) and send an order response 116 to the computing device 102. For example, the order response 116 may provide an estimate as to (1) when each of the items 112 are expected to ship, (2) when each of the items 112 are expected to arrive at the destination address, and (3) other order-related information (e.g., payment confirmation, rewards confirmation, invoice information, etc.).

The server 104 may receive and process the order request 114 by determining the items 112 that the user checked out using the cart 110. The server 104 may determine a set of (e.g., one or more) attributes associated with each of the items 112 in the cart 110. For example, the server 104 may determine a set of attributes 118(1) associated with the item 112(1) and determine a set of attributes 118(N) associated with the item 112(N). Each of the set of attributes 118 may include attributes, such as, for example, a fulfillment location identifier, a line of business identifier, which other items a particular item is associated with, is tied to, ships with, or the like, whether the particular item is a child item (and the parent item associated with the child item), whether the particular item is a parent item (and the child items associated with the parent item), a country restriction or a regional restriction (e.g., for example particular items may not be shipped to particular countries or regions due to import laws or export laws), and other attributes as described herein.

The server 104 may apply, using a rule engine 132, one or more rules 120(1) to 120(M) (where M>0) to the items 112 in the cart 110 to create one or more sub-carts 128(1) to 128(P) (where P>0). Each of the sub-carts 128 may include a subset of one or more of the items 112. For example, the sub-cart 128(1) may include a subset of items 130(1) of the items 112 and the sub-cart 128(P) may include a subset of items 130(P) of the items 112. Each of the rules 120 may include an attribute, a condition, and an action to perform when the condition is satisfied. For example, the rule 120(1) may include an attribute 122(1), a condition 124(1), and an action 126(1) and the rule 120(M) may include an attribute 122(M), a condition 124(M), and an action 126(M). The rule engine 132 may determine whether each of the rules 120 applies to each of the items 112. For example, if the rule engine 132 determines that the set of attributes 118(N) includes the attribute 122(M) and satisfies the condition 124(M), then the rule engine 132 may perform the action 126(M).

To illustrate, assume the cart 110 includes an order for 1000 units (e.g., one of the attributes 118(N)) of the item 112(N), and assume the rule 120(M) specifies that if the cart 110 includes an order for more than 500 units of the item 112(N), then the order is to be split so that a particular one of the sub-carts 128 has no more than 500 units. In this example, the attribute 122(M) is the number of units, the condition 124(M) is greater than 500, and the action 126(M) is to split the items so that a first of the sub-carts 128 has 500 units of item 112(N) and a second of the sub-carts 128 has 500 units of item 112(N).

As another illustration, assume at least two of the items 112 (e.g., 112(1) and 112(N)) have the same fulfillment location identifier attribute, and the rule 120(M) specifies that items having the attribute of the same fulfillment location identifier are to be grouped in the same one of the sub-carts 128. In this example, the attribute 122(M) is the fulfillment location identifier, the condition 124(M) is same/equal, and the action 126(M) is to group the items. Thus, for example, the set of attributes 118(1) may include a particular fulfillment location identifier and the set of attributes 118(N) may include the same particular fulfillment location identifier. In this example, both the item 112(1) and the item 112(N) may be placed in the same sub-cart, e.g., sub-cart 128(P). Of course, other of the items 112 that have a second particular fulfillment location identifier may be placed in the same sub-cart, e.g., sub-cart 128(1).

The attributes 122 may include a fulfillment location identifier (e.g., identifying a location from which the item is to be fulfilled), a brand identifier (e.g., identifying a brand or manufacturer of the item), quote number (e.g., a sales person provided a written quote), quantity (e.g., a quantity that exceeds a threshold amount may be split and fulfilled from two or more locations), ships with (e.g., indicating that an item ships with another item), tied to (e.g., indicating that an item is associated with another item), parent-child association (e.g., indicating that an item, such as a warranty, is a child item of another item), and the like. The conditions 124 may include greater than, greater than or equal to, less than, less than or equal to, equal to (e.g., same as), including, excluding, and the like. The actions 126 may include splitting (e.g., each item having a particular attribute that satisfies a particular condition is placed into a separate sub-cart), grouping (e.g., each item having a particular attribute that satisfies a particular condition is placed into a same sub-cart).

Note that some of the actions 126 may cause both splitting and grouping of the items 112. For example, an action to group items having the same fulfillment location into the same sub-cart may result in a first item being placed into a first sub-cart and a second item being placed into a second sub-cart, when the first item has a different fulfillment location than the second item. The same action may group a third item and a fourth item in the same sub-cart, such as a third sub-cart, when the third item and the fourth item have the same fulfillment location.

After the rule engine 132 has applied the rules 120 to the items 112 in the cart 110 to create the sub-carts 128, each of the sub-carts 128 may be sent to a particular fulfillment center to fulfill a portion of the order. For example, the sub-cart 128(1) may be sent to a first fulfillment location and the sub-cart 128(P) may be sent to a P^{th} fulfillment location.

Thus, a server may receive and process an order sent by a customer from a computing device. The server may identify items included in the order (e.g., items added to a cart and the checked out) and identify one or more attributes associated with each item in the order. The server may use a rule engine to apply one or more rules to the items in the order. Each rule may include an attribute, a condition, and an action to be performed if the attribute satisfies the condition. The actions may include splitting two or more items into two or more sub-carts (e.g., a first item goes into a first sub-cart and a second item are placed in a second sub-cart) or grouping two or more items into the same sub-cart (e.g., a first item and a second item are placed in a same sub-cart). For example, a rule may specify that items that are associated with each other or have a parent-child relationship, such as a laptop (parent), a battery pack (child), a power supply (child), and a warranty (child) may be grouped together (e.g., into the same sub-cart). Expanding on this example, assume a user orders two different types of laptops. The first laptop (parent) may be grouped into first sub-cart with a first battery pack (child), a first power supply (child), and a first warranty (child). The second laptop (parent) may be grouped into second sub-cart with a second battery pack (child), a second power supply (child), and a second warranty (child). In this example, the first sub-cart may be sent to a first fulfillment location and the second sub-cart may be sent to a second fulfillment location. As another example, a rule may specify that particular items that have the same fulfillment location identifier, indicating that the particular items are to be shipped from the same fulfillment center (e.g., warehouse) may be grouped together in the same sub-cart. As yet another example, a rule may specify that if the quantity of a particular item exceeds a threshold (e.g., condition), then the quantity of the particular item in each sub-cart is not to exceed a particular amount. After the server has applied the rules to the items in the cart to create one or more sub-carts, each of the sub-carts may be sent to a particular fulfillment center to fulfill a portion of the order. For example, a first sub-cart may be sent to a first fulfillment center, a second sub-cart may be sent to a second fulfillment center, and so on.

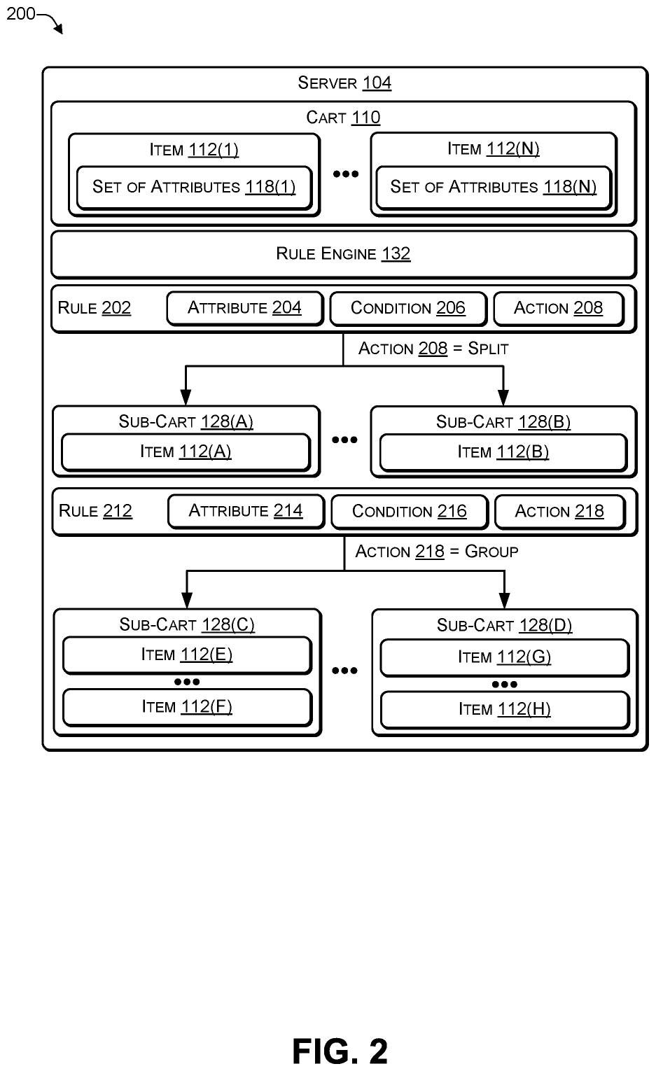

FIG. 2 is a block diagram 200 illustrating applying multiple rules to an order (e.g., cart) according to some embodiments. As previously discussed, the server 104 may receive the order request 114 from the computing device 102 of FIG. 1 and retrieve the cart 110. The server 104 may determine the items 112 in the cart 110 and the set of attributes 118 associated with each of the items 112.

The rule engine 132 may apply a rule 202 (e.g., one of the rules 120 of FIG. 1) to the items 112 in the cart 110. The rule 202 may specify an attribute 204, a condition 206, and an action 208. In FIG. 2, the action 208 is to split two or more of the items 112 into two or more sub-carts 128(A) to 128(B) (where B>A>0). For example, the rule engine 132 may apply the rule 202, thereby placing an item 112(A) in the sub-cart 128(A) and placing an item 112(B) into sub-cart 128(B). For example, the rule 202 may specify that the items 112 are to be split according to fulfillment location. In this example, the item 112(A) may be placed in the sub-cart 128(A) because one of the attributes of the item 112(A) indicates that the item 112(A) is associated with a first fulfillment location. The item 112(B) may be placed in the sub-cart 128(B) because one of the attributes of the item 112(B) indicates that the item 112(B) is associated with a second fulfillment location. In this example, the items 112(A) and 112(B) are split into two different sub-carts 128(A) and 128(B), respectively, based on the fulfillment location attribute.

The rule engine 132 may apply a rule 212 (e.g., one of the rules 120 of FIG. 1) to the items 112 in the cart 110. The rule 212 may specify an attribute 214, a condition 216, and an action 218. In FIG. 2, the action 218 is to group two or more of the items 112 into a single one of the sub-carts 128(C) to 128(D) (where D>C>0). For example, the rule engine 132 may apply the rule 212, thereby placing items 112(E) to 112(F) (F>E>0) in the sub-cart 128(C) and placing items 112(G) and 112(H) (H>F>0) into sub-cart 128(B). For example, the rule 212 may specify that the items 112 are to be grouped according to “ships with”, “associated with”, or “child of”. In this example, the items 112(E) to 112(F) may be placed in the sub-cart 128(C) because the item 112(E) is a laptop and the item 112(F) is either a warranty associated with the laptop, a power supply associated with the laptop, or a battery pack associated with the laptop. The items 112(G) to 112(H) may be placed in the sub-cart 128(D) because the item 112(G) is a tablet computing device and the item 112(H) is either a warranty associated with the tablet or a power supply associated with the tablet. In this example, the items 112(E) to 112(F) are grouped into sub-cart 128(C) and the items 112(G) to 112(H) are grouped into sub-cart 128(D), based on the associated with (or child of) attribute.

Thus, a server may receive and process an order sent by a customer from a computing device. The server may identify items included in the order (e.g., items added to a cart and the checked out) and identify one or more attributes associated with each item in the order. The server may use a rule engine to apply one or more rules to each of the items in the order that cause each item to be placed into a particular sub-cart. Each rule may include an attribute, a condition, and an action to be performed if the attribute satisfies the condition. The actions may include splitting two or more items into two or more sub-carts (e.g., a first item goes into a first sub-cart and a second item are placed in a second sub-cart) or grouping two or more items into the same sub-cart (e.g., a first item and a second item are placed in a same sub-cart). For example, a rule may specify that items that are associated with each other or have a parent-child relationship, such as a laptop (parent), a battery pack (child), a power supply (child), and a warranty (child) may be grouped together (e.g., into the same sub-cart). In this example, a first laptop (parent) may be grouped into first sub-cart with a first battery pack (child), a first power supply (child), and a first warranty (child) and a second laptop (parent) may be grouped into second sub-cart with a second battery pack (child), a second power supply (child), and a second warranty (child). The first sub-cart may be sent to a first fulfillment location and the second sub-cart may be sent to a second fulfillment location. As another example, a rule may specify that particular items that have the same fulfillment location identifier, indicating that the particular items are to be shipped from the same fulfillment center (e.g., warehouse) are grouped together in the same sub-cart. Thus, a first set of items that are fulfilled from a first fulfillment center may be grouped together in a first sub-cart and a second set of items that are fulfilled from a second fulfillment center may be grouped together in a second sub-cart. After the server has applied the rules to the items in the cart to create one or more sub-carts, each of the sub-carts may be sent to a particular fulfillment center to fulfill a portion of the order. For example, a first sub-cart may be sent to a first fulfillment center, a second sub-cart may be sent to a second fulfillment center, and so on.

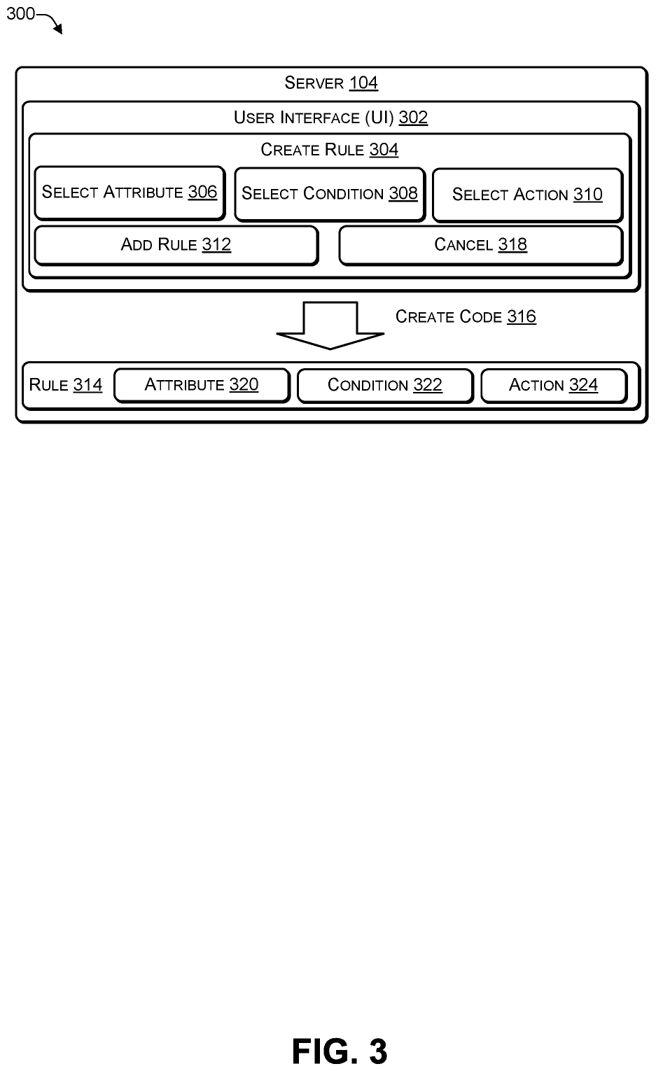

FIG. 3 is a block diagram 300 of a user interface (UI) 302 to create a rule according to some embodiments. The UI 302 may enable users, including users who are not software programmers, to create and maintain (e.g., update) rules, such as the rules 120 applied by the rule engine 132 of FIG. 1.

The UI 302 may provide a create rule 304 UI element that enables a user to specify an attribute using a select attribute 306 (e.g., a dropdown menu or other) UI element. For example, in response to the user selecting the select attribute 306 UI element, the UI 302 may display a list of attributes from which the user can select a particular attribute, such as, for example, a fulfillment location identifier (e.g., identifying a location from which the item is to be fulfilled), a brand identifier (e.g., identifying a brand or manufacturer of the item), quote number (e.g., a sales person provided a written quote), quantity (e.g., a quantity that exceeds a threshold amount may be split and fulfilled from two or more locations), ships with (e.g., indicating that an item ships with another item), tied to (e.g., indicating that an item is associated with another item), parent-child association (e.g., indicating that an item, such as a warranty, is a child item of another item), and the like.

The UI 302 may enable a user to specify a condition using a select condition 308 (e.g., a dropdown menu or other) UI element. For example, in response to the user selecting the select condition 308 UI element, the UI 302 may display a list of conditions from which the user can select a particular condition, such as, for example, greater than, greater than or equal to, less than, less than or equal to, equal to (e.g., same as), including, excluding, destination country or region, and the like.

The UI 302 may enable a user to specify an action to be performed when the selected attribute satisfies the selected condition using a select action 310 (e.g., a dropdown menu or other) UI element. For example, in response to the user selecting the select action 310 UI element, the UI 302 may display actions, such as, for example, splitting (e.g., each item having a particular attribute that satisfies a particular condition is placed into a separate sub-cart), grouping (e.g., each item having a particular attribute that satisfies a particular condition is placed into a same sub-cart), and the like.

After specifying an attribute using the select attribute 306, specify a condition using the select condition 308, and specifying an action using the select action 310, the user may select an add rule 312 UI element to create a rule 314. For example, selecting the add rule 312 UI element may cause the server 104 to create software code 316 implementing (e.g., creating) the rule 314 including an attribute 320 (specified using the select attribute 306 UI element), a condition 322 (specified using the select condition 308 UI element), and an attribute 320 (specified using the select action 310 UI element). The user may select cancel 318 to cancel creation of a rule and exit the create rule 304 UI.

Thus, a UI may enable a user to quickly and easily create a rule by selecting an attribute from a set of attributes, selecting a condition from a set of conditions, and selecting an action from a set of actions. After selecting an attribute, a condition, and an action, the user may select “add rule” to cause software code implementing the rule to be created and add to the set of rules.

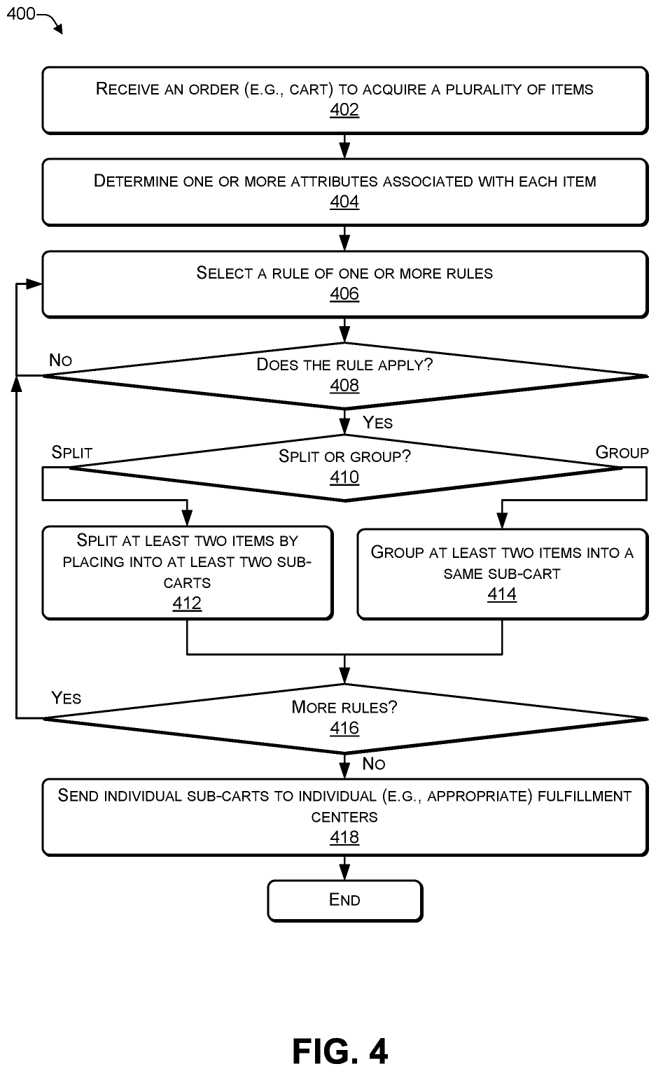

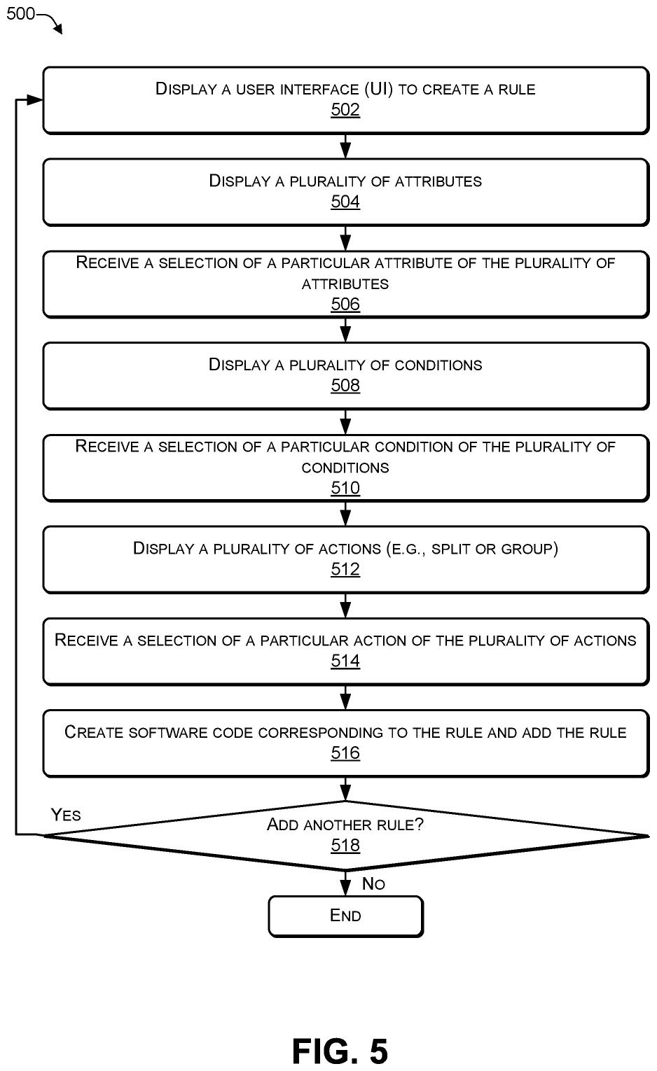

In the flow diagram of FIGS. 4 and 5, each block represents one or more operations that can be implemented in hardware, software, or a combination thereof. In the context of software, the blocks represent computer-executable instructions that, when executed by one or more processors, cause the processors to perform the recited operations. Generally, computer-executable instructions include routines, programs, objects, modules, components, data structures, and the like that perform particular functions or implement particular abstract data types. The order in which the blocks are described is not intended to be construed as a limitation, and any number of the described operations can be combined in any order and/or in parallel to implement the processes. For discussion purposes, the processes 400 and 500 are described with reference to FIGS. 1, 2, and 3 as described above, although other models, frameworks, systems and environments may be used to implement these processes.

FIG. 4 is a flowchart of a process 400 that includes applying one or more rules to an order (e.g., cart) according to some embodiments. The process 400 may be performed by the rule engine 132 of FIG. 1 and FIG. 2.

At 402, an order to acquire (e.g., purchase or lease) a plurality of items (e.g., software, hardware, services, and the like) may be received. At 404, one or more attributes associated with each item may be determined. For example, in FIG. 1, the server 104 may receive the order request 114 requesting that the order associated with the cart 110 be fulfilled. The server 104 may identify the cart 110, the items 112 in the cart 110, and the set of attributes 118 associated with each of the items 112.

At 406, a rule may be selected from one or more rules. At 408, a determination may be made whether the selected rule applies (e.g., whether the condition and the attribute associated with an item in the order are satisfied). If a determination is made, at 408, that the selected rule does not apply, then the process may proceed to 406 where another rule may be selected from the one or more rules. If a determination is made, at 408, that the selected rule applies, then the process may proceed to 410. For example, in FIG. 1, the rule engine 132 may select one of the rules 120 and determine whether the corresponding attribute 122 and condition 124 are satisfied by the set of attributes 118 associated with each of the items 112. If the rule engine 132 determines that the selected rule of the rules 120 does not apply, then the rule engine 132 may select another of the rules 120. If the rule engine 132 determines that the selected rule of the rules 120 does apply, then the rule engine 132 may perform the corresponding action 126 associated with the selected rule. For example, two or more of the items from the items 112 may be split into two or more of the sub-carts 128 or two or more of the items from the items 112 may be grouped into a same one of the sub-carts 128.

At 410, a determination may be made whether to split items or group items based on the selected rule. In response to determining, at 410, to split items, the process may proceed to 412, where at least two items are split by placing at least a first item into a first sub-cart and at least a second item into a second sub-cart. The process may then proceed to 416. In response to determining, at 410, to group items, the process may proceed to 414, where at least two items are grouped by placing the at least two items into a same sub-cart. The process may then proceed to 416. For example, in FIG. 1, if the attribute 122 and the condition 124 of one of the rules 120 applies to one of the items 112 (e.g., based on an attribute from the set of attributes 118 satisfying the attribute 122 and the condition 124), then the corresponding action 126 may be performed. For example, if the attribute 122(M) and the condition 124(M) of the rule 120(M) applies to the item 112(N) (e.g., based on an attribute from the set of attributes 118(N) satisfying the attribute 122(M) and the condition 124(M)), then the corresponding action 126(M) may be performed. For example, in FIG. 2, the rule 202 may split two items by placing the item 112(A) in the sub-cart 128(A) and placing the item 112(B) into the sub-cart 128(B). As another example, the rule 212 may group items by placing the items 112(E) to 112(F) in the sub-cart 128(C) and by placing the items 112(G) to 112(H) in the sub-cart 128(D).

At 416, a determination may be made whether there are more rules to be applied. If a determination is made, at 416, that more rules are to be applied (e.g., at least one rule has not yet been applied), the process may proceed to 406, where another rule may be selected from the one or more rules. For example, in FIG. 1, the rule engine 132 may determine whether all of the rules 120 have been selected. If all of the rules 120 have not been selected, then one of the rules 120 that was not previously selected may be selected.

If a determination is made, at 416, that no more rules are to be applied, the process may proceed to 418, where individual sub-carts may be electronically sent to corresponding fulfillment centers, after which, the process may end. For example, in FIG. 1, if the rule engine 132 determines that all of the rules 120 have been selected, then server 104 may send each of the sub-carts 128 to a particular (e.g., associated) fulfillment location.

Thus, a server may receive and process an order sent by a customer from a computing device. The server may identify items included in the order (e.g., items added to a cart and the checked out) and identify one or more attributes associated with each item in the order. The server may use a rule engine to apply one or more rules to each of the items in the order that cause each item to be placed into a particular sub-cart. Each rule may include an attribute, a condition, and an action to be performed if the attribute satisfies the condition. The actions may include splitting two or more items into two or more sub-carts (e.g., a first item goes into a first sub-cart and a second item are placed in a second sub-cart) or grouping two or more items into the same sub-cart (e.g., a first item and a second item are placed in a same sub-cart). For example, a rule may specify that items that are associated with each other or have a parent-child relationship, such as a laptop (parent), a battery pack (child), a power supply (child), and a warranty (child) may be grouped together (e.g., into the same sub-cart). In this example, a first laptop (parent) may be grouped into first sub-cart with a first battery pack (child), a first power supply (child), and a first warranty (child) and a second laptop (parent) may be grouped into second sub-cart with a second battery pack (child), a second power supply (child), and a second warranty (child). The first sub-cart may be sent to a first fulfillment location and the second sub-cart may be sent to a second fulfillment location. As another example, a rule may specify that particular items that have the same fulfillment location identifier, indicating that the particular items are to be shipped from the same fulfillment center (e.g., warehouse) are grouped together in the same sub-cart. Thus, a first set of items that are fulfilled from a first fulfillment center may be grouped together in a first sub-cart and a second set of items that are fulfilled from a second fulfillment center may be grouped together in a second sub-cart. After the server has applied the rules to the items in the cart to create one or more sub-carts, each of the sub-carts may be sent to a particular fulfillment center to fulfill a portion of the order. For example, a first sub-cart may be sent to a first fulfillment center, a second sub-cart may be sent to a second fulfillment center, and so on.

FIG. 5 is a flowchart of a process 500 to create a rule according to some embodiments. The process 500 may be performed by the UI 302 of FIG. 3.

At 502, a UI to create a rule may be displayed. At 504, a plurality of attributes may be displayed. At 506, a selection of a particular attribute of the plurality of attributes may be received. At 508, a plurality of conditions may be displayed. At 510, a selection of a particular condition of the plurality of conditions may be received. At 512, a plurality of actions may be displayed. At 512, a selection of a particular action of the plurality of actions may be received. At 516, software code implementing the rule may be created and add to the rules used by the rule engine. At 518, a determination may be made whether to add another rule (e.g., based on whether the user indicates that the user desires to add another rule). If a determination is made, at 518, to add another rule, then the process proceeds to 502 where the UI to create a rule is displayed. If a determination is made, at 518, to not add another rule, then the process ends.

For example, in FIG. 3, the UI 302 may provide a create rule 304 UI element. In response to the user selecting the select attribute 306 UI element, the UI 302 may display a list of attributes from which the user can select a particular attribute, such as, for example, a fulfillment location identifier (e.g., identifying a location from which the item is to be fulfilled), a brand identifier (e.g., identifying a brand or manufacturer of the item), quote number (e.g., a sales person provided a written quote), quantity (e.g., a quantity that exceeds a threshold amount may be split and fulfilled from two or more locations), ships with (e.g., indicating that an item ships with another item), tied to (e.g., indicating that an item is associated with another item), parent-child association (e.g., indicating that an item, such as a warranty, is a child item of another item), and the like.

In response to the user selecting the select condition 308 UI element, the UI 302 may display a list of conditions from which the user can select a particular condition, such as, for example, greater than, greater than or equal to, less than, less than or equal to, equal to (e.g., same as), including, excluding, destination country or region, and the like.

In response to the user selecting the select action 310 UI element, the UI 302 may display actions, such as, for example, splitting (e.g., each item having a particular attribute that satisfies a particular condition is placed into a separate sub-cart), grouping (e.g., each item having a particular attribute that satisfies a particular condition is placed into a same sub-cart), and the like.

After specifying an attribute using the select attribute 306, specify a condition using the select condition 308, and specifying an action using the select action 310, the user may select an add rule 312 UI element to create a rule 314. For example, selecting the add rule 312 UI element may cause the server 104 to create software code 316 implementing (e.g., creating) the rule 314 including an attribute 320 (specified using the select attribute 306 UI element), a condition 322 (specified using the select condition 308 UI element), and an attribute 320 (specified using the select action 310 UI element). The user may select cancel 318 to cancel creation of a rule and exit the create rule 304 UI.

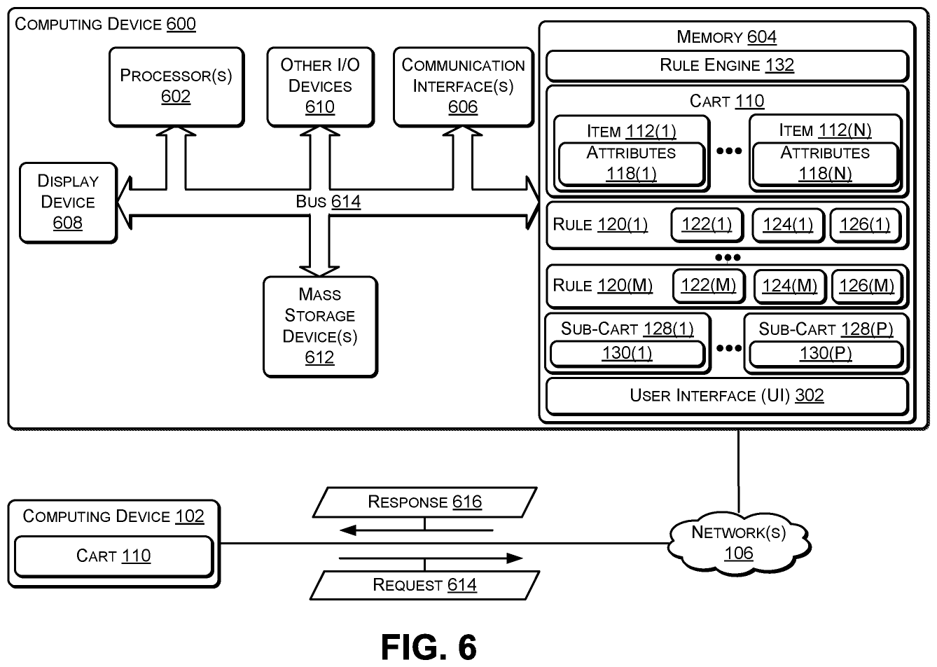

FIG. 6 illustrates an example configuration of a computing device 600 that can be used to implement the systems and techniques described herein, such as for example, the server 104 or the computing device 102. The computing device 600 may include one or more processors 602 (e.g., CPU, GPU, or the like), a memory 604, communication interfaces 606, a display device 608, other input/output (I/O) devices 610 (e.g., keyboard, trackball, and the like), the sensors 206, and one or more mass storage devices 612 (e.g., disk drive, solid state disk drive, or the like), configured to communicate with each other, such as via one or more system buses 614 or other suitable connections. While a single system bus 614 is illustrated for ease of understanding, it should be understood that the system buses 614 may include multiple buses, such as a memory device bus, a storage device bus (e.g., serial ATA (SATA) and the like), data buses (e.g., universal serial bus (USB) and the like), video signal buses (e.g., ThunderBolt®, DVI, HDMI, and the like), power buses, etc.

The processors 602 are one or more hardware devices that may include a single processing unit or a number of processing units, all of which may include single or multiple computing units or multiple cores. The processors 602 may include a graphics processing unit (GPU) that is integrated into the CPU or the GPU may be a separate processor device from the CPU. The processors 602 may be implemented as one or more microprocessors, microcomputers, microcontrollers, digital signal processors, central processing units, graphics processing units, state machines, logic circuitries, and/or any devices that manipulate signals based on operational instructions. Among other capabilities, the processors 602 may be configured to fetch and execute computer-readable instructions stored in the memory 604, mass storage devices 612, or other computer-readable media.

Memory 604 and mass storage devices 612 are examples of computer storage media (e.g., memory storage devices) for storing instructions that can be executed by the processors 602 to perform the various functions described herein. For example, memory 604 may include both volatile memory and non-volatile memory (e.g., RAM, ROM, or the like) devices. Further, mass storage devices 612 may include hard disk drives, solid-state drives, removable media, including external and removable drives, memory cards, flash memory, floppy disks, optical disks (e.g., CD, DVD), a storage array, a network attached storage, a storage area network, or the like. Both memory 604 and mass storage devices 612 may be collectively referred to as memory or computer storage media herein and may be any type of non-transitory media capable of storing computer-readable, processor-executable program instructions as computer program code that can be executed by the processors 602 as a particular machine configured for carrying out the operations and functions described in the implementations herein.

The computing device 600 may include one or more communication interfaces 606 for exchanging data via the network 110. The communication interfaces 606 can facilitate communications within a wide variety of networks and protocol types, including wired networks (e.g., Ethernet, DOCSIS, DSL, Fiber, USB etc.) and wireless networks (e.g., WLAN, GSM, CDMA, 802.11, Bluetooth, Wireless USB, ZigBee, cellular, satellite, etc.), the Internet and the like. Communication interfaces 606 can also provide communication with external storage, such as a storage array, network attached storage, storage area network, cloud storage, or the like.

The display device 608 may be used for displaying content (e.g., information and images) to users. Other I/O devices 610 may be devices that receive various inputs from a user and provide various outputs to the user, and may include a keyboard, a touchpad, a mouse, a printer, audio input/output devices, and so forth.

The computer storage media, such as memory 116 and mass storage devices 612, may be used to store software and data. For example, the computer storage media may be used to store the cart 110, the items 112, the attributes 118 associated with each of the items 112, the rules 120 (including the attributes 122, the conditions 124, and the actions 126), the sub-carts 128 (with each of the sub-carts 128 including a corresponding subset of items 130), and the UI 302.

Thus, the server 104 of FIG. 1 (e.g., as implemented using the computing device 600) may receive and process an order sent in the request 614 by a customer from the computing device 102. The server 104 may identify the items 112 included in the order (e.g., items added to the cart 110) and identify one or more attributes 118 associated with each of the items 112 in the cart 110. The server 104 may use the rule engine 132 to apply the rules 120 to the items 112 in the cart 110. Applying the rules 120 may result in each of the items 112 being placed into a particular sub-cart 128. Each of the rules 120 may include the attribute 122, the condition 124, and the action 126 that is to be performed if the attribute 122 satisfies the condition 124. The actions 126 may include splitting two or more items 112 into two or more sub-carts 128 (e.g., a first item is placed into a first sub-cart and a second item is placed in a second sub-cart) or grouping two or more of the items 112 into the same sub-cart (e.g., a first item and a second item are placed in a same sub-cart).

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

Although the present invention has been described in connection with several embodiments, the invention is not intended to be limited to the specific forms set forth herein. On the contrary, it is intended to cover such alternatives, modifications, and equivalents as can be reasonably included within the scope of the invention as defined by the appended claims.

What is claimed is:

1. A method comprising:
receiving, by the one or more processors, an order to acquire a plurality of items;
determining, by the one or more processors, a set of attributes associated with individual items of the plurality of items;
selecting, by the one or more processors, a rule from one or more rules, the rule including a rule attribute, a rule condition, and a rule action;
determining, by the one or more processors, that the rule applies to a first item of the plurality of items;
placing, by the one or more processors, the first item in a first sub-cart based on the rule action included in the first rule; and
sending, by the one or more processors, the first sub-cart to a first fulfillment location identified by a fulfillment location identifier attribute in the set of attributes associated with the first item.

2. The method of claim 1, wherein determining that the rule applies to the first item of the plurality of items comprises:
determining that a particular attribute of the set of attributes associated with the first item satisfies the rule attribute and the rule condition of the rule.

3. The method of claim 1, further comprising:
determining that the rule applies to a second item of the plurality of items; and
placing the second item in the first sub-cart based on the rule action included in the first rule.

4. The method of claim 3, wherein:
a second set of attributes associated with the second item includes the fulfillment location identifier attribute that is associated with the first item.

5. The method of claim 3, wherein:
the second item includes a child attribute indicating that the second item is a child of the first item.

6. The method of claim 3, wherein:
the second item includes a ships-with attribute indicating that the second item ships with the first item.

7. The method of claim 1, further comprising:
determining that a second rule applies to a third item of the plurality of items;
placing the third item in a second sub-cart based on a second rule action included in the second rule; and
sending the second sub-cart to a second fulfillment location identified by a second fulfillment identifier attribute in a third set of attributes associated with the third item.

8. A server comprising:
one or more processors; and
one or more non-transitory computer readable media storing instructions executable by the one or more processors to perform operations comprising:
receiving an order to acquire a plurality of items;
determining a set of attributes associated with individual items of the plurality of items;
selecting a rule from one or more rules, the rule including a rule attribute, a rule condition, and a rule action;
determining that a first attribute of a first set of attributes associated with a first item satisfies the rule attribute and the rule condition included in the rule;
placing the first item in a sub-cart based on the rule action included in the rule; and
sending the first sub-cart to a first fulfillment location identified by a fulfillment location identifier attribute in the set of attributes associated with the first item.

9. The server of claim 8, the operations further comprising:
determining that a second attribute of a second set of attributes associated with a second item satisfies the rule attribute and the rule condition included in the rule; and
placing the second item in the first sub-cart based on the rule action included in the rule.

10. The server of claim 8, wherein the first set of attributes associated with the first item comprises:
a fulfillment location identifier that identifies a location from which the first item is to be shipped;
a brand identifier that identifies a brand or a manufacturer of the first item;
a quantity associated with the first item; and
a ships with indicator indicating that the first item ships with another item.

11. The server of claim 8, wherein the rule condition included in the first rule comprises one of:
greater than;
greater than or equal to;
less than;
less than or equal to;
equal to;
including; or
excluding.

12. The server of claim 8, wherein the rule action comprises one of:
splitting a particular item from the plurality of items by placing the particular item in a particular sub-cart; or
grouping the particular item with a different item from the plurality of items by placing the particular item and the different item in a same sub-cart.

13. The server of claim 8, further comprising:
determining that a second rule applies to a third item of the plurality of items;
placing the third item in a second sub-cart based on a second rule action included in the second rule; and
sending the second sub-cart to a second fulfillment location identified by a third fulfillment location identifier in a third set of attributes associated with the third item.

14. One or more non-transitory computer readable media storing instructions executable by one or more processors to perform operations comprising:
determining a set of attributes associated with individual items of the plurality of items;
selecting a rule from one or more rules, the rule including a rule attribute, a rule condition, and a rule action;
determining that the rule applies to a first item of the plurality of items;
placing the first item in a first sub-cart based on the rule action included in the first rule; and
sending the first sub-cart to a first fulfillment location identified by a fulfillment location identifier attribute in the set of attributes associated with the first item.

15. The one or more non-transitory computer readable media of claim 14, wherein determining that the first rule applies to the first item of the plurality of items comprises:
determining that a particular attribute of the set of attributes associated with the first item satisfies the rule attribute and the rule condition of the rule.

16. The one or more non-transitory computer readable media of claim 14, the operations further comprising:
determining that the rule applies to a second item of the plurality of items; and
placing the second item in the first sub-cart based on the rule action included in the first rule.

17. The one or more non-transitory computer readable media of claim 16, wherein:
a second set of attributes associated with the second item includes the fulfillment location identifier attribute that is associated with the first item.

18. The one or more non-transitory computer readable media of claim 16, wherein:
the second item includes a child attribute indicating that the second item is a child of the first item.

19. The one or more non-transitory computer readable media of claim 14, wherein:
the second item includes a ships-with attribute indicating that the second item ships with the first item.

20. The one or more non-transitory computer readable media of claim 17, the operations further comprising:
determining that a second rule applies to a third item of the plurality of items;
placing the third item in a second sub-cart based on a second rule action included in the second rule; and
sending the second sub-cart to a second fulfillment location identified by a second fulfillment identifier attribute in a third set of attributes associated with the third item.
